(19) United States
(12) Patent Application Publication
(10) Pub. No.: US 2025/0223463 A1
(43) Pub. Date: Jul. 10, 2025

(54) POLYURETHANE PREPOLYMER COMPOSITION, LAMINATE AND PREPARATION PROCESS AND USE THEREOF

(71) Applicant: BASF SE, Ludwigshafen Am Rhein (DE)

(72) Inventors: Zhong Kai ZHANG, Shanghai (CN); Feng QIN, Shanghai (CN); Dong Liang WANG, Shanghai (CN)

(21) Appl. No.: 18/727,807

(22) PCT Filed: Jan. 13, 2023
(86) PCT No.: PCT/EP23/50691

§ 371 Date: Jul. 10, 2024

(30) Foreign Application Priority Data
Jan. 25, 2022 (WO) PCT/CN22/73724

(51) Int. Cl. C09D 175/08; C08G 18/12; C08G 18/20; C08G 18/30; C08K 3/26; C08K 3/34; C09D 7/61

(52) U.S. Cl. CPC C09D 175/08; C08G 18/12; C08G 18/2081; C08G 18/307; C09D 7/61; C08K 2003/265; C08K 2003/343

(57) ABSTRACT

Disclosed herein is a polyurethane prepolymer composition, including a reaction product of an isocyanate component and a polyol component, where the reaction product includes isocyanate groups at an amount of from 5.0 to 13.0 wt %, based on the total weight of the isocyanate component and the polyol component, and the polyol component has a functionality in a range of from 1.5 to 3.0. Further disclosed herein is a laminate including the polyurethane prepolymer composition. Additionally disclosed herein are a process of preparing the polyurethane prepolymer composition, the laminate, and a method of using the laminate.

### TECHNICAL FIELD

The present invention relates to polyurethane prepolymer composition, laminate and preparation process and use thereof.

### BACKGROUND

Polyurethane (PU) synthetic leather normally consists of a top coat layer, a base coat layer and a substrate, wherein the properties of the base coat layer is key for the properties of the resulting synthetic leather. For example, according to the requirements in application, some synthetic leathers need to have embedded logo, and whether the logo can be obtained mainly depends on the property of the base coat layer. One-component or two-component polyurethane composition comprising solvent has been used for producing base coat layer. Since non-solvent PU synthetic leather is one of eco-friendly solutions for synthetic leather industry, there has been developed some solvent-free solutions based on two-component polyurethane or water based sheet as base coat layer. However, for producing those two-component polyurethane or water based sheet, it needs high temperature curing which costs a large amount of energy. In addition, the obtained sheets have insufficient performance, such as peel strength, flexing endurance and embossing property.

WO2009/119752 A discloses a solvent-free polyurethane-urea foam sheet which is produced by foaming a solvent-free urethane resin composition with air or an inert gas, shaping the foamed material into a sheet-like material, and hardening the sheet-like material by heating. The solvent-free urethane resin composition comprises (A) a prepolymer produced by the reaction between a diisocyanate compound with a polyol having a molecular weight of 500 to 3000, (B) a cross-linking agent comprising a polyol having 2 to 4 hydroxy groups on average, and (C) water, wherein the residual amount of an isocyanate group in a mixture of the components (A) and (B) is 2.0 to 5.0% by mass, the residual amount of an isocyanate group in a mixture of the components (A), (B) and (C) is 0.01 to 0.5% by mass, and the number average molecular weight of all of the polyol used as a raw material for the component (A) and the polyol of the component (B) is 600 or more. However, this patent discloses using high curing temperature of 80-130° C. and does not involve the logo embedding property of the foam sheet.

CN103483529 A discloses a manufacturing method of polyurethane foam sheet through combination of moisture curing reaction and foaming reaction, wherein a reaction production containing prepolymer with a NCO of 20-25 wt % has excellent viscosity at room temperature even without organic solvent and requires no heating for melting. However, this patent application also discloses using high curing temperature of 80-130° C. and does not involve the logo embedding property of the foam sheet.

Therefore, it is still required to provide new polyurethane prepolymer formulation and preparation process, so as to obtain laminate or synthetic leather with improved properties, which may overcome one or more the above disadvantages.

### SUMMARY OF THE INVENTION

An objective of this invention is to overcome the problems of the prior art discussed above and to provide a polyurethane prepolymer composition and preparation process thereof. The polyurethane prepolymer composition is a one-component system, whose curing involves water or moisture and do not need to be mixed with a polyol composition. Meanwhile, the final synthetic leather based on the polyurethane product obtained from the polyurethane prepolymer composition achieves improved properties in terms of embossing property, as well as curing performance, peel strength and flexing endurance. Furthermore, the laminate or synthetic leather can be prepared at lower curing temperature of 45-90° C.

Surprisingly, it has been found by the inventors that the above objective may be achieved by providing a polyurethane prepolymer composition, comprising a reaction product of
an isocyanate component; and
a polyol component,
wherein the reaction product comprises isocyanate groups, the amount of the isocyanate groups is 5.0 to 13.0 wt %, based on the total weight of the isocyanate component and the polyol component, and the polyol component has a functionality in the range of from 1.5 to 3.0.

In a preferable embodiment of the invention, in the polyurethane prepolymer composition, the amount of the isocyanate groups is 8.0 to 12.5 wt %, preferably 9.0 to 12.0 wt %, more preferably 10.0 to 11.0 wt %, each based on the total weight of the isocyanate component and the polyol component.

In a preferable embodiment of the invention, the polyurethane prepolymer composition contains no blocked isocyanate group (NCO); that is, preferably, the polyurethane prepolymer composition merely contains isocyanate group in native form, without isocyanate group in blocked form.

In a preferable embodiment of the invention, the isocyanate component is selected from aliphatic diisocyanates, aliphatic polyisocyanates, cycloaliphatic diisocyanates, cycloaliphatic polyisocyanates, aromatic diisocyanates, aromatic polyisocyanates, and any mixture thereof, preferably the isocyanate component is diphenylmethane diisocyanate.

In a preferable embodiment of the invention, the polyol component (B) has a functionality in the range of from 1.9 to 2.8, preferably 2.0 to 2.6.

In a preferable embodiment of the invention, the polyol component (B) has a weight-average molecular weight in the range of from 500 g/mol to 10000 g/mol and OH value in the range of from 20 to 400 mgKOH/g.

In a preferable embodiment of the invention, the polyurethane prepolymer composition further comprises at least one catalyst which is selected from a tin compound, an amine compound, an imidazole compound, a morpholine compound, such as 2,2-dimorpholinodiethylether, and any mixture thereof.

In a preferable embodiment of the invention, the polyurethane prepolymer composition further comprises at least one filler which is selected from calcium carbonate, carbon black, silica, hydrated silica, alumina, titania, zinc oxide, talc, mica, clay, kaolinite, wollastonite, montmorillonite, aluminum hydroxide, barium sulfate, lignin, wood fiber, wood flour, monohydrate, dihydrate, trihydrate, tetrahydrate, and pentahydrate of magnesium carbonate, monohydrate, tetrahydrate, pentahydrate, hexahydrate, and heptahydrate of magnesium sulfate, copper(II) sulfate pentahydrate, calcium sulfate hemihydrate, calcium sulfate dihydrate, ferrous sulfate heptahydrate, aluminum potassium sulfate dodecahydrate, sodium sulfate decahydrate, sodium metasilicate pentahydrate, sodium metasilicate nonahydrate, and any mixture thereof.

Another objective of this invention is to provide a process for producing the polyurethane prepolymer composition, wherein the process comprises mixing all the components of the composition until uniform.

Another objective of this invention is to provide a laminate comprising the polyurethane prepolymer composition as mentioned above.

In a preferable embodiment of the invention, the polyurethane prepolymer composition used as a base coat layer is sandwiched between a top coat skin layer and a substrate layer to form a laminate.

In a preferable embodiment of the invention, the laminate is a synthetic leather, especially an embossable or embeddable synthetic leather.

Further objective of this invention is to provide a process for producing the laminate, comprising the following steps:
(1) applying the polyurethane prepolymer composition onto a release paper; and
(2) curing the applied composition in the presence of water,
wherein in the curing step (2), the temperature is in a range of 45-90° C., preferably 50-85° C., more preferably 50-80° C.

In a preferable embodiment of the invention, the water is present in the form of moisture and/or in the form of water contained in the filler, such as crystallization water of the filler and free water absorbed and/or adsorbed by the filler.

In a preferable embodiment of the invention, the water is introduced in the curing step (2) by controlling the moisture at the curing atmosphere.

In a preferable embodiment of the invention, the water is introduced in the curing step (2) by adding a filler which has water of crystallization, absorbed free water and/or adsorbed free water.

In a preferable embodiment of the invention, the moisture has a relative humidity in a range of 30-95%, preferably 40-70%, more preferably 45-65%.

In a preferable embodiment of the invention, the filler is selected from monohydrate, dihydrate, trihydrate, tetrahydrate and pentahydrate of magnesium carbonate, monohydrate, tetrahydrate, pentahydrate, hexahydrate and heptahydrate of magnesium sulfate, copper(II) sulfate pentahydrate, calcium sulfate hemihydrate, calcium sulfate dihydrate, ferrous sulfate heptahydrate, aluminum potassium sulfate dodecahydrate, sodium sulfate decahydrate, sodium metasilicate pentahydrate, sodium metasilicate nonahydrate, and any mixture thereof.

Another objective of this invention is to provide use of the laminate in apparel, accessories, package, electronic devices, furniture, upholstery, decorations, sports items, or leisure products.

It has been surprisingly found that the inventive laminate or synthetic leather has improved properties in terms of embossable or logo embedding property, as well as curing performance, peel strength and flexing endurance by using innovative nonsolvent one-component polyurethane prepolymer composition as a base coat layer. Furthermore, the laminate or synthetic leather can be prepared at lower curing temperature of 45-90° C.

### DESCRIPTION OF FIGURES

FIG. 1 shows the process for preparing a PU synthetic leather comprising the inventive one-component polyurethane prepolymer composition as a base coat layer.

FIG. 2 shows a logo embedding on the inventive PU synthetic leather.

### DETAILED DESCRIPTION OF THE INVENTION

Unless defined otherwise, all technical and scientific terms used herein have the meaning commonly understood by a person skilled in the art to which the invention belongs. As used herein, the following terms have the meanings ascribed to them below, unless specified otherwise.

As used herein, the articles “a” and “an” refer to one or to more than one (i.e., to at least one) of the grammatical object of the article or component.

Unless otherwise identified, all percentages (%) are “percent by weight”, denoted as wt %.

Unless otherwise identified, the molecular weight of each component or polymer means a weight-average molecular weight.

Unless otherwise identified, relative humidity (R.H.) means the ratio of the partial pressure of water vapor in wet air to the saturation pressure of water at the same temperature.

Unless otherwise identified, isocyanate group refers to the organic radical —N═C═O, denoted also as —NCO.

Unless otherwise identified, isocyanate refers to an organic compound with one or more isocyanate groups. Diisocyanate refers to an organic compound with two (2) isocyanate groups. Polyisocyanate refers to an organic compound with three (3) or more isocyanate groups.

Unless otherwise identified, polyol refers to an organic compound with two or more hydroxyl (—OH) groups.

Unless otherwise identified, OH value (sometime also termed as “hydroxyl value” or “hydroxyl number”) is a measure of the concentration of the hydroxyl groups in a polyol or a polyol component. The OH value is calculated as the number of milligrams of potassium hydroxide required to neutralize the acetic acid taken up on acetylation of one gram of a chemical substance (in the present invention, a polyol, or a polyol component) that contains free hydroxyl groups.

Unless otherwise identified, functionality (abbreviated as “Fn”) of a polyol or a polyol component refers to the number or average number of OH groups per molecule.

As used herein, the term “blocked isocyanate group” is used in its ordinary meaning to those skilled in the art, who understand it to mean a blocked isocyanate group (such as a urethane or urea moiety) in its structure, obtained by reaction of a native isocyanate group (—NCO) with an isocyanate blocking agent. For many blocked isocyanates, the blocking occurs through a reaction with a compound containing an active hydrogen, such as an alcohol, a phenol, an amide, or an amine. The blocked isocyanate group can be converted to the native isocyanate group by heating the blocked isocyanate at an elevated temperature.

As used herein, the term “polyurethane prepolymer” is intended to mean macromolecules or oligomers formed from reaction between one or more polyols and one or more diisocyanates and/or polyisocyanates, where the diisocyanates and/or polyisocyanates are in excess quantities. Usually, polyurethane prepolymers may contain isocyanate groups in blocked or native form. In the present invention, the polyurethane prepolymer composition preferably contains no blocked isocyanate group.

As used herein, the amount of isocyanate groups is calculated based on the weight of the isocyanate groups and the total weight of the isocyanate component and the polyol component. The amount of blocked isocyanate groups is calculated based on the weight of blocked isocyanate groups and the total weight of the isocyanate component and the polyol component.

The present invention provides a polyurethane prepolymer composition, comprising a reaction product of
an isocyanate component; and
a polyol component,
wherein the reaction product comprises isocyanate groups, the amount of the isocyanate groups is 5.0 to 13.0 wt %, based on the total weight of the isocyanate component and the polyol component; and the polyol component has a functionality in the range of from 1.5 to 3.0.

It should be noted that the reaction product of the isocyanate component and the polyol component contains unreacted or free isocyanate groups. The polyurethane prepolymer composition can undergo a curing process to be made into final products. The polyurethane prepolymer composition can be stable for a long period of time under certain storage conditions. The polyurethane prepolymer composition can be prepared in situ before the curing process, or, alternatively, can be stored after preparation and then cured for producing final products.

In the present invention, the polyurethane prepolymer composition comprises, an isocyanate component (A), a polyol component (B), optionally a catalyst (C), and optionally, chain extender and/or crosslinking agent (D), blowing agent (E), filler (F) and additives and/or auxiliaries (G), such as pigments, thickener, wetting agent, and antioxidants.

### Isocyanate Component (A)

In the present invention, the isocyanate component (A) comprises at least one isocyanate. Isocyanates used for producing the polyurethane prepolymer composition of the invention comprise all isocyanates known for producing polyurethanes. Isocyanates can be any diisocyanate or polyisocyanate. These diisocyanates and polyisocyanates comprise aliphatic, cycloaliphatic, araliphatic and/or aromatic isocyanates, such as tri-, tetra-, penta-, hexa-, hepta- and/or octamethylene diisocyanate, 2-methylpentamethylene 1,5-diisocyanate, 2-ethylbutylene 1,4-diisocyanate, pentamethylene 1,5-diisocyanate, butylene 1,4-diisocyanate, 1-isocyanato-3,3,5-trimethyl-5-isocyanatomethylcyclohexane (isophorone diisocyanate, IPDI), 1,4- and/or 1,3-bis(isocyanatomethyl)cyclohexane (HXDI), cyclohexane 1,4-diisocyanate, 1-methylcyclohexane 2,4- and/or 2,6-diisocyanate and/or dicyclohexylmethane 4,4′-, 2,4′- and 2,2′-diisocyanate, diphenylmethane 2,2′-, 2,4′- and/or 4,4′-diisocyanate (MDI), polymeric MDI, naphthylene 1,5-diisocyanate (NDI), tolylene 2,4- and/or 2,6-diisocyanate (TDI), 3,3′-dimethyl diphenyl diisocyanate, 1,2-diphenylethane diisocyanate and/or phenylene diisocyanate. Particular preference is given to using diphenylmethane 2,2′-, 2,4′- and/or 4,4′-diisocyanate, and polymeric MDI, especially diphenylmethane 4,4′-diisocyanate or diphenylmethane 2,4′-diisocyanate or the mixture thereof, such as a mixture in a weight ratio of 1:1.

In the present invention, in the polyurethane prepolymer composition, the amount of the isocyanate group (NCO) is 5.0 to 13.0 wt %, based on the total weight of the polyurethane composition.

It has been surprisingly found in this invention that the isocyanate group (NCO) amount in the polyurethane prepolymer composition has important influence on the properties of the inventive laminate or leather obtained from the polyurethane prepolymer composition. The amount of the isocyanate group (NCO) is 8.0 to 12.5 wt %, preferably 9.0 to 12.0 wt %, more preferably 10.0 to 11.0 wt %, each based on the total weight of the isocyanate component and the polyol component, in combination of the specific polyol component (B) below, leads to excellent properties of the inventive polyurethane product, especially embossing or logo embedding property, especially logo embedding property, as well as peel strength, curing property and/or flexing endurance. The inventors have found that blocked isocyanate group (NCO) has adverse impact on the properties of the polyurethane prepolymer composition, and thus in the present invention, the polyurethane prepolymer composition preferably contains no blocked isocyanate group.

### Polyol Component (B)

In the present invention, the polyol component (B) comprises at least one polyol. The polyol used is selected from polyols having a functionality in the range of from 1.5 to 3.0, preferably a functionality in the range of from 1.9 to 2.8, more preferably 2.0 to 2.6.

The polyol used preferably has a weight-average molecular weight in the range of from 500 g/mol to 10000 g/mol, preferably from 800 g/mol to 6000 g/mol, more preferably from 900 g/mol to 4000 g/mol and OH value in the range of from 20 to 400 mgKOH/g, preferably from 20 to 300 mgKOH/g, more preferably from 20 to 200 mgKOH/g.

The polyol component (B) can be a single polyol or a mixture of at least two single polyols. Preferably, the polyol component (B) is a mixture of at least two single polyols. Preferably, a polyether polyol mixture is use as the polyol.

The suitable polyether polyols preferably have a weight-average molecular weight in the range of from 850 g/mol to 1500 g/mol, preferably from 900 g/mol to 1200 g/mol, have functionality in the range of from 1.9 to 2.1, and have OH value in the range of from 50 to 400 mgKOH/g, preferably 100 to 200 mgKOH/g. Those polyether polyols can be polyether polyols obtained by ring-opening polymerization of oxygen-containing heterocyclic compounds comprising 3 to 6 carbon atoms, such as tetrahydrofuran. Preferably, the polyol is produced by polymerizing tetrahydrofuran as repeating unit, preferably capped with primary hydroxyl.

The used polyether polyols also preferably have a weight-average molecular weight in the range of from 3000 g/mol to 4000 g/mol, preferably from 3200 g/mol to 3600 g/mol, have functionality in the range of from 1.5 to 2.0, and have OH value in the range of from 20 to 200 mgKOH/g, preferably 20 to 60 mgKOH/g. Those polyether polyols can be polyether polyols are produced by polymerizing epoxides, such as ethylene oxide and/or propylene oxide, as repeating unit and using propylene glycol as starter, preferably capped by ethylene oxide with primary hydroxyl group.

The used polyether polyols also preferably have a weight-average molecular weight in the range of from 1000 g/mol to 3000 g/mol, preferably from 1500 g/mol to 2500 g/mol, and has functionality in the range of from 1.8 to 2.0, and have OH value in the range of from 20 to 200 mgKOH/g, preferably from 30 to 100 mgKOH/g. Those polyether polyols can be polyether polyol obtained by homopolymerization of diols, such as propylene glycol, ethylene glycol or butanediol.

The used polyether polyols also preferably have a weight-average molecular weight in the range of from 3500 g/mol to 5000 g/mol, preferably from 4000 g/mol to 4500 g/mol, and has functionality in the range of from 2.5 to 2.9, preferable 2.6-2.8, and have OH value in the range of from 20 to 200 mgKOH/g, preferably from 25 to 100 mgKOH/g. The polyether polyol is preferably based on epoxide, such as ethylene oxide (EO) and propylene oxide (PO). Those polyether polyols can be polyether polyol produced by polymerizing epoxides, such as produced by ethylene oxide and/or propylene oxide, as repeating unit and using glycerol as starter, preferably capped by ethylene oxide with primary hydroxyl group.

In a preferable embodiment according to the present invention, the polyol comprises the mixture of the above polyether polyol deriving from tetrahydrofuran and the above polyether polyol deriving from epoxides, in a weight ratio of 1:1-3, preferable 1:1-1.5.

In a preferable embodiment according to the present invention, the polyol comprises the mixture of the above polyether polyol deriving from epoxides and the above polyether polyol deriving from homopolymerization of diols, in a weight ratio of 1:1-3, preferable 1:1-1.5.

The polyols used in the present invention are produced by known processes or can be commercially available.

In the present invention, the polyol component (B), if in a form of mixture, has an average functionality (FAv) of from 1.5 to 2.1. Preferably, the polyol component (B) has an average functionality of from 1.8 to 2.0, more preferably from 1.9 to 2.0.

In the present invention, FAv means the average functionality of multiple polyols contained in polyol component (a), and represents by the following formula:

$$FAv = MR 1 * F 1 + MR 2 * F 2 + MR 3 * F 3 + … ,$$

wherein MR1 is the mole ratio of the first polyol in polyol component (B) and F1 is the functionality of the first polyol in polyol component (B); MR2 is the mole ratio of the second polyol in polyol component (B) and F2 is the functionality of the second polyol in polyol component (B); MR3 is the mole ratio of the second polyol in polyol component (B) and F2 is the functionality of the third polyol in polyol component (B); . . . .

In the present invention, the molecular weights of each component were determined use gel permeation chromatography (GPC), according to GB/T 21863-2008.

In the present invention, the OH values of each polyol component were determined in accordance with DIN 53240.

In the present invention, the functionality (Fn) means number of terminal hydroxyl groups per polyol molecule. The functionality is determined by the following formula:

$$Fn = Mn * ( OHv ) / 56100$$

wherein Mn represents number-average molecular weight of a polyol and OHv represents OH values of polyol component.

### Catalyst (C)

As catalyst (C), it is possible to use all compounds which accelerate the isocyanate-polyol reaction. Such compounds are known and are described, for example, in “Kunststoffhandbuch, volume 7, Polyurethane”, Carl Hanser Verlag, 3rd edition 1993, chapter 3.4.1. These comprise amine-based catalysts and catalysts based on organic metal compounds, or the mixture of thereof.

As catalysts based on organic metal compounds, it is possible to use, for example, organic tin compounds such as tin(II) salts of organic carboxylic acids, e.g. tin(II) acetate, tin(II) octoate, tin(II) ethylhexanoate and tin(II) laurate, and the dialkyltin(IV) salts of organic carboxylic acids, e.g. dibutyltin diacetate, dibutyltin dilaurate, dibutyltin maleate and dioctyltin diacetate, and also Zn salts or Bi salts, e.g., zinc octoate, bismuth(III) neodecanoate, bismuth 2-ethylhexanoate and bismuth octanoate, or alkali metal salts of carboxylic acids, e.g. potassium acetate or potassium formate.

As amine-based catalysts, it is possible to use, for example, strongly basic amines such as N,N,N-triethylaminoethoxyethanol, bis(N,N-dimethylaminoethyl)ether, dimethyl cyclohexylamine, trimethyl hydroxyethyl ethylenediamine, dimethylbenzylamine, triethylamine, triethylenediamine, pentamethyldipropylenetriamine, dimethylethanolamine, tetramethylhexamethylenediamine, tris(dimethylaminopropyl) hexahydrotriazine, dimethylaminopropylamine, diazabicycloundecene, diazabicyclononene. diazabicyclooctane, preferably triethylenediamine or bis(N,N-dimethylaminoethyl)ether.

As imidazole or morpholine based catalysts, it is possible to use, for example, imidazole, N-methylimidazole, N-ethylimidazole, N-ethylmorpholine, 2,2-dimorpholinodiethylether.

The catalyst (C) used in the invention can be commercially available.

Typically, the amount of the catalyst (C) is preferably from 0.05 to 5 wt %, more preferably from 0.5 to 3 wt %, based on the total weight of the isocyanate component and the polyol component.

The catalyst can also be employed for curing the polyurethane prepolymer composition for producing a variety of articles, for example, a sheet, a molded article, a foam, etc.

### Chain Extender and Crosslinking Agent (D)

Chain extenders and/or crosslinking agents (D) that can be used are substances having a molar mass which is preferably smaller than 500 g/mol, particularly preferably from 60 to 400 g/mol, wherein chain extenders have 2 hydrogen atoms reactive toward isocyanates and crosslinking agents have 3 hydrogen atoms reactive toward isocyanate. These can be used individually or preferably in the form of a mixture. It is preferable to use diols and/or triols having molecular weights smaller than 500, particularly from 60 to 400, and in particular from 60 to 350. Examples of those that can be used are aliphatic, cycloaliphatic, and/or araliphatic diols having from 2 to 14, preferably from 2 to 10, carbon atoms, e.g., ethylene glycol, 1,3-propanediol, 1,4-butanediol, 1,6-hexanediol, 1,10-decanediol, 1,2-, 1,3-, and 1,4-dihydroxycyclohexane, diethylene glycol, dipropylene glycol, tripropylene glycol, diethanolamine, or triols, e.g., 1,2,4- or 1,3,5-trihydroxycyclohexane, glycerol, and trimethylolpropane. Preference is given to using ethylene glycol, 1,3-propanediol, or 1,4-butanediol, especially 1,4-butanediol.

The amount of chain extender and/or crosslinking agent is preferably from 0.5 to 5 wt %, more preferably from 1.5 to 4.5 wt %, based on the total weight of the isocyanate component and the polyol component.

### Blowing Agent (E)

The system also may comprise blowing agent (E). Suitable blowing agents (E) are known as such to those skilled in the art and are selected, for example, from the group consisting of carbon dioxide, alkanes such as propane, isobutane and pentane, alcohols such as methanol, 1-propanol, 2-propanol, 1-butanol, 2-butanol, 2-methylpropanol and tert-butanol, ethers such as dimethyl ether, ketones such as acetone or methyl ethyl ketones, halogenated hydrocarbons such as hydrofluoropropene, water, nitrogen, and mixtures of these. Preferably, water is used as the sole blowing agent.

The amount of blowing agent (E) is preferably from 0.1 to 5 wt %, more preferably from 0.1 to 1.0 wt %, based on the total weight of the isocyanate component and the polyol component.

### Filler (F)

Filler can be mixed with the polyurethane prepolymer composition during the curing process. The filler can adjust or improve mechanical, optical, electrical, acoustic, or thermal properties or other qualities, for example, visual appearance and surface quality, of the final product made from the polyurethane prepolymer composition.

According to the present invention, filler can be selected from calcium carbonate, carbon black, silica, hydrated silica, alumina, titania, zinc oxide, talc, mica, clay, kaolinite, wollastonite, montmorillonite, aluminum hydroxide, barium sulfate, lignin, wood fiber, wood flour, monohydrate, dihydrate, trihydrate, tetrahydrate, and pentahydrate of magnesium carbonate, monohydrate, tetrahydrate, pentahydrate, hexahydrate, and heptahydrate of magnesium sulfate, copper(II) sulfate pentahydrate CuSO₄·5H₂O (CAS 7758-99-8), calcium sulfate hemihydrate CaSO₄·0.5H₂O (CAS10034-76-1), calcium sulfate dihydrate CaSO₄·2H₂O (CAS10101-41-4), ferrous sulfate heptahydrate FeSO₄·7H₂O (CAS 7782-63-0), aluminum potassium sulfate dodecahydrate KAI(SO₄)₂·12H₂O (CAS 7784-24-9), sodium sulfate decahydrate Na₂SO₄·10H₂O (CAS 7727-73-3), sodium metasilicate pentahydrate Na₂SiO₃·5H₂O (CAS 10213-79-3) and sodium metasilicate nonahydrate Na₂SiO₃·9H₂O (CAS 13517-24-3), and any mixture thereof. Among those, calcium carbonate, aluminum hydroxide, and the above-mentioned compounds containing water of crystallization are preferable. The amount of filler is from 0 to 200 wt %, preferably from 1 to 50 wt %, more preferably from 5 to 40 wt %, based on the total weight of the isocyanate component and the polyol component.

The filler may contain water in the form of a content, such as free water absorbed and/or adsorbed by the filler, or in the form of water of crystallization. As an example, the filler may be a wet calcium carbonate, or contain water of crystallization within lattice of the fillers. The following compounds are particularly preferred: calcium carbonate, sodium metasilicate pentahydrate and sodium metasilicate nonahydrate. The filler may contain 0.05 to 65 wt % of water, preferably 0.10 to 60 wt % of water, more preferably 0.10 to 55 wt % of water, based on the total weight of the filler.

The fillers can also be any mixture of different fillers described above.

Additives and/or Auxiliaries (G)

Additives and/or auxiliaries (G) that can be used comprise surfactants, preservatives, pigment, colorants, antioxidants, silicone oil leveling agent, stabilizers, thickener, wetting agent, and reinforcing agents. In preparing the non-solvent polyurethane system, it is generally to employ one of above additives and/or auxiliaries, or the mixture thereof, so as to improve the properties of the obtained polyurethane product, such as texture duplicate, peel strength, flexing endurance and curing property.

Typically, the amount of additives and/or auxiliaries is preferably from 0 to 12 wt %, more preferably from 0.1 to 10 wt %, based on the total weight of the isocyanate component and the polyol component.

According to the present invention, thickener, wetting agent, and antioxidant are preferably used. Those materials that can be used, if present, include all thickener, wetting agent, and antioxidant commonly used in the non-solvent polyurethane system. The amount of each of them is preferably from 0.1 to 5 wt %, more preferably from 0.5 to 1 wt %, each based on the total weight of the non-solvent polyurethane system.

Further information concerning the mode of use and of action of the above-mentioned auxiliaries and additives, and also further examples, are given by way of example in “Kunststoffhandbuch, Band 7, Polyurethane” [“Plastics handbook, volume 7, Polyurethanes”], Carl Hanser Verlag, 3rd edition 1993, chapter 3.4.

The inventive polyurethane prepolymer composition can be cured at temperature of 45-90° C., preferably 50-85° C., more preferably 50-80° C., even more preferably 50-70° C., especially 50-65° C., in the presence of water to form desired polyurethane product.

The water may be present in moisture as in a moisture curing process. In the moisture curing process, the water has such an amount that makes reactants to be formed into the desired polyurethane product (such as polyurethane sheet) at relative humidity in a range of 30-95%, preferably 40-70%, more preferably 45-65%.

The water may be present in the filler added to the polyurethane prepolymer composition before or during curing. The water can be free water absorbed and/or adsorbed by the filler or water of crystallization within lattice of the filler, which can be released from the filler under the temperature during curing. The filler can be selected from calcium carbonate, carbon black, silica, hydrated silica, alumina, titania, zinc oxide, talc, mica, clay, kaolinite, wollastonite, montmorillonite, aluminum hydroxide, barium sulfate, lignin, wood fiber, wood flour, monohydrate, dihydrate, trihydrate, tetrahydrate, and pentahydrate of magnesium carbonate, monohydrate, tetrahydrate, pentahydrate, hexahydrate, and heptahydrate of magnesium sulfate, copper(II) sulfate pentahydrate, calcium sulfate hemihydrate, calcium sulfate dihydrate, ferrous sulfate heptahydrate, aluminum potassium sulfate dodecahydrate, sodium sulfate decahydrate, sodium metasilicate pentahydrate, sodium metasilicate nonahydrate, or the mixture thereof. The filler may contain water in the form of a content, or in the form of water of crystallization. The filler may contain 0.05 to 65 wt % of water, preferably 0.10 to 60 wt % of water, more preferably 0.10 to 55 wt % of water, based on the total weight of the filler. As known by those skilled in the art, fillers containing water or capable of releasing water (e.g., water of crystallization) may introduce water into the polyurethane prepolymer composition. Under an elevated temperature, for example, a temperature of 45-90° C., the introduced water may react with the polyurethane prepolymer composition and facilitate curing process.

In the present invention, the relative humidity can be adjusted by any method known to those in the art, for example, moisture control oven can be used to form desired relative humidity with water.

The present invention further provides a process for producing the polyurethane prepolymer composition, comprising comprises mixing the isocyanate component and the polyol component until uniform, i.e., forming a homogeneous mixture. The methods for mixing can be any conventional methods used in the art, such as mechanical stirring.

The present invention further provides a laminate, which is obtained from the inventive polyurethane prepolymer composition.

In the present invention, the polyurethane prepolymer composition used as a base coat layer is sandwiched between a top coat skin layer and a substrate layer. That is, the laminate comprises a base coat layer formed from polyurethane prepolymer composition and the top coat skin layer or/and the substrate layer.

In the present invention, the laminate is a synthetic leather, especially an embossable or embeddable synthetic leather.

The present invention further provides a process for producing the laminate, comprising the following steps:
(1) applying the polyurethane prepolymer composition onto a release paper; and
(2) curing the applied composition in the presence of water,
wherein in the curing step (2), the temperature is in a range of 45-90° C., preferably 50-85° C., more preferably 50-80° C.

In the present invention, the water is introduced in the curing step (2) by controlling the moisture at the curing atmosphere.

In the present invention, the water is introduced in the curing step (2) by adding a filler which has water of crystallization, absorbed free water and/or adsorbed free water.

In the present invention, the moisture is controlled to have a relative humidity in a range of 30-95%, preferably 40-70%, more preferably 45-65%. As mentioned above, the moisture is provided by the water, which is in the form of moisture and/or is contained in the filler and formed into moisture by heating.

In the present invention, the filler used in the above process is selected from monohydrate, dihydrate, trihydrate, tetrahydrate and pentahydrate of magnesium carbonate, monohydrate, tetrahydrate, pentahydrate, hexahydrate and heptahydrate of magnesium sulfate, copper(II) sulfate pentahydrate, calcium sulfate hemihydrate, calcium sulfate dihydrate, ferrous sulfate heptahydrate, aluminum potassium sulfate dodecahydrate, sodium sulfate decahydrate, sodium metasilicate pentahydrate, sodium metasilicate nonahydrate, and any mixture thereof.

In the present invention, in the step (1), applying method can be used to make the polyurethane prepolymer composition formed layer or sheet-like material, such as dip coating, knife coating, roller coating and spin coating.

The present invention further provides use of the laminate as an upper material in apparel and accessories, as covering materials for cases and electronic devices, as synthetic leather coverings in furniture/upholstery area, decorations, sports items, or leisure products.

The present laminate may be used in anywhere as a replacement of genuine leather. For example, in apparel and accessories as an upper material for handbags, shoes, boots, gloves, hats or outerwear items like jackets, pants and belts. It could also be used as covering materials for cases and electronic devices, such as suitcases, briefcases, watch bands, smartphone cases, earphone cases and camera cases. In addition, in furniture/upholstery area, the present laminate could be used as synthetic leather coverings for sofas, car seats, car interiors, chairs, cushion and coffee tables, and in certain types of decorations such as wall hangings. Besides, the present laminate could also be used in sports items or leisure products, like game balls, saddles, toys, etc.

### Top Coat Layer

In the present invention, the top coat layer may be any layer capable of combining with the base coat layer in the art. Suitable aqueous polyurethane dispersion used to form the top coat skin layer discloses in, for example PCT/CN2020/084834, the contents of which are expressly incorporated herein by reference.

### Base Coat Layer

In the present invention, the base coat layer is obtained from the polyurethane prepolymer composition according to the present invention.

The present invention further provides a laminate produced by the polyurethane prepolymer composition. The present laminate can be used as the base coat layer for producing a synthetic leather. The synthetic leather comprises a substrate layer, wherein the substrate layer is underneath the base coat layer. The top coat layer and the base coat layer are as defined above. The substrate layer is obtained as follows:

### Substrate Layer

In the present application, the synthetic leather comprises a substrate layer underneath the base coat layer. In principle, the substrate layer may be any layer capable of forming an adhering bond with the base coat layer. The thickness of the substrate layer is typically in the range from 0.01 mm to 20 mm, preferably in the range from 0.1 mm to 15 mm. The substrate layer is, for example, non-woven fabric, textile, genuine leather, wood, TPU, other plastic or split leather. One preferred embodiment utilizes non-woven fabric or split leather as the substrate layer.

The PU sheet/laminate/leather can be processed by many ways, for examples:

The PU sheet/laminate/leather is continuously embossed by a hot embossing roller with the temperature of 150-250° C., and then the texture/pattern is duplicated.

The PU sheet/laminate/leather is heated to desired temperature, such as 150-250° C., then the leather is continuously embossed by the embossing roller without heater.

The PU sheet/laminate/leather is heated to the desired temperature, such as 150-250° C., then leather continuously sucked by the vacuum embossing roller that has tiny hollows and textured surface.

The PU sheet/laminate/leather is embossed by a hot plat plate (150-250° C.), and not a continuous way like the embossing roller.

The PU sheet/laminate/leather is pressed by a hot stamper or plate (150-250° C.) with the designed brand logo or character in a very short time, such as 1-10 seconds.

In the present application, curing performance test for the PU sheet/laminate/leather proceeded under shorter curing time of 10 minutes and under longer curing time of 15 or 30 minutes. If the curing performance is excellent at the shorter time, the product is suitable for a continuous production process in the actual production. If the curing performance is excellent until the longer time, the product is more suitable for a non-continuous production process in the actual production.

### EXAMPLES

The present invention will now be described with reference to Examples and Comparative Examples, which are not intended to limit the present invention.

The following raw materials were used:

Polyol #1 is a polypropylene glycol with a functionality of 1.93, OH value 55 mg KOH/g.

Polyol #2 is produced by polymerizing ethylene oxide as repeating unit and using propylene glycol as starter, and capped by ethylene oxide with primary hydroxyl groups, with a functionality of 1.76, and OH value of 29.5 mgKOH/g.

Polyol #3 is produced by polymerizing tetrahydrofuran as repeating unit, and capped with primary hydroxyl, with a functionality of 2, and OH value of 112.3 mgKOH/g.

Polyol #4 is produced by polymerizing ethylene oxide as repeating unit and using glycerol as starter, and capped by ethylene oxide with primary hydroxyl groups, with a functionality of 2.72, and OH value of 35 mgKOH/g.

Polyol #5 is produced by polymerizing ethylene oxide and polypropylene oxide as repeating unit and using TDA (toluenediamine) as starter, and capped by polypropylene oxide, with a functionality of 3.8, and OH value of 405 mgKOH/g.

Isocyanate (ISO) #1: Lupranat MS-C from BASF.

Isocyanate (ISO) #2: Lupranat MI from BASF.

Catalyst: 2,2-dimorpholinodiethylether, shortened as “DMDEE” (CAS: 6425-39-4).

Filler 1: CaCO₃, containing 0.35 wt % of water.

Filler 2: Sodium metasilicate nonahydrate (CAS 13517-24-3), shortened as “SMNH”.

These raw materials were used to prepare formulations and comparative formulations of PU prepolymers, denoted as “For. 1 through 10” and “Comp. For. 1 through 7”. Then, several synthetic leather samples were made from the polyurethane prepolymer compositions by process described hereinafter, denoted as “Exp. 1 through 10” and “Comp. Exp. 1 through 7”. The synthetic leather samples made from the same polyurethane prepolymer composition, for example, For. 7, under different curing conditions (temperature, relative humidity, or amount of filler) were denoted as, for example, Exp. 7-1, Exp. 7-2, etc.

To compare the PU synthetic leather samples with commercially available synthetic leather products, a solvent based PU leather and a water-based PU leather were used. The solvent based PU leather was made from DMF-based polyurethane resin (from Warren Synthetic Leather (Suzhou) CO., LTD). The water-based PU leather was made from water-based polyurethane resin (from Warren Synthetic Leather (Suzhou) CO., LTD).

### Property Test

### Test of Peel Strength

Peel strength testing was carried out to the PU artificial leathers that were just peeled from the release paper after curing, and the testing should be finished within 20 minutes, including specimen preparation and testing. The test follows the standard SATRA TM 411.

### Test of Curing Property

Curing property was judged by using nail to press the top coat of the PU synthetic leather and then visually evaluating according to the following grades:
Grade 1: nail print is rebound>10 seconds, or the top coat is damaged;
Grade 2: nail print rebound (7-9 seconds);
Grade 3: nail print rebound (4-6 seconds);
Grade 4: nail print rebound (1-3 seconds);
Grade 5: no obvious nail print.

### Test of Flexing Endurance

Flexing endurance test was carried out according to the standard ISO 5402 as follows:

Test pieces of the PU synthetic leather were prepared according to ISO 2418, including cutting at least three vertical test pieces and at least three horizontal test pieces, conditioning the test pieces according to ISO 2419 and performing the test in conditioned atmosphere. After 25× magnification, the test pieces were visually evaluated in terms of the cracks/loss of adhesion/change of color shade. The expression “pass” indicates no visible cracks/loss of adhesion/visible change of color shade. The expression “fail” means there is damage on the test pieces.

### Test of Logo Embedding Property:

Logo embedding property test was carried out as follows:

The PU laminate/leather is pressed by a hot stamper or plate (150-250° C.) with the designed brand logo or character in a very short time, such as 1-10 seconds.

The logo embedding machine is Model 380 (Nanjing Yueyi Clothing Co. Ltd) assembled with tailor-made embossing plat. The logo embedding process is as follows:
(1) Setting the temperature to 160° C., and waiting until the embossable plate keeps a constant temperature;
(2) Setting pressing time to 1 second;
(3) Placing the leather sample on the console, pressing the pressure button first, and then pressing the operation button with both hands. Once the process is completed, the embossing plate automatically moves up, and then the sample can be collected.

3D profile meter measuring system from Keyence (Model: VR-3200) was used to measure the depth of embedding logo. A logo usually includes one or more shapes or characters. FIG. 2 shows a logo consisting of two squares, four letters “B”, “A”, “S”, and “F” in a bigger font, and a slogan in a smaller font. As shown in table 1, the first square, denoted as “Square 1”, is a bigger square with its center portion extracted; the second square, denoted as “Square 2”, is a smaller square. In logo embedded synthetic leathers, the logo is formed by pressing the synthetic leather to obtain a depressed area or several discontinuous depressed areas. Within a designated area of 3.5 cm*1.2 cm in a leather sample, a maximum height relative to a reference plane is measured and its value is denoted as ΔHmax. Similarly, a minimum height relative to the same reference plane is measured and its value is denoted as ΔHmin. The difference ΔHmax−ΔHmin is expressed as the depth of embedding logo. In this test, ΔHmax and ΔHmin were measured on six designated areas (the two squares, the letters “B”, “A”, “S”, and “F” in the bigger font) of the leather sample, and the average of the six ΔHmax−ΔHmin values was reported as the depth of embedding logo.

TABLE 1

| | Logo | ΔHmax − ΔHmin, mm |
|---|---|---|
| Exp. 2-1 | Square 1 | 0.66 |
| | Square 2 | 0.61 |
| | B | 0.74 |
| | A | 0.72 |
| | S | 0.63 |
| | F | 0.66 |
| | Average | 0.67 |

### Preparation of PU Prepolymer

The following components in table 2 were used to prepare the PU prepolymer. In each case, all the components of the PU prepolymer were mixed to form a mixture for forming the base coat layer of PU synthetic leather.

TABLE 2

| | | | | | | | Comp. | | | | Comp. | |
|---|---|---|---|---|---|---|---|---|---|---|---|---|
| Weight/part | For. 1 | For. 2 | For. 3 | For. 4 | For. 5 | For. 6 | For. 1 | For. 7 | For. 8 | For. 9 | For. 2 | For. 10 |
| ISO #1 | — | — | — | — | — | — | — | 39.8 | 27 | — | — | — |
| ISO #2 | 36.6 | 36.6 | 44.4 | 41.6 | 39.0 | 23.4 | 20 | — | — | 35.5 | 37.5 | 36.6 |
| Polyol #1 | 31.7 | 31.7 | 27.8 | 29.2 | 30.5 | 38.3 | 40 | — | — | — | — | 31.7 |
| Polyol #2 | 31.7 | 31.7 | 27.8 | 29.2 | 30.5 | 38.3 | 40 | 30.1 | 36.6 | — | — | 31.7 |
| Polyol #3 | — | — | — | — | — | — | — | 30.1 | 36.6 | — | — | — |
| Polyol #4 | — | — | — | — | — | — | — | — | — | 64.5 | 56.8 | — |
| Polyol #5 | — | — | — | — | — | — | — | — | — | — | 3.4 | — |
| CaCO₃ | — | 30 | 30 | 30 | 30 | 30 | 30 | 30 | 30 | 30 | 30 | — |
| SMNH | — | — | — | — | — | — | — | — | — | — | — | 1 |
| DMDEE | 2 | 2 | 2 | 2 | 2 | 2 | 2 | 2 | 2 | 2 | 2 | — |
| NCO/% | 10.1 | 10.1 | 12.9 | 11.9 | 11.0 | 5.2 | 3.9 | 10.0 | 5.0 | 10.1 | 10.1 | 10.1 |
| Polyol Fn | 1.9 | 1.9 | 1.9 | 1.9 | 1.9 | 1.9 | 1.9 | 2.0 | 2.0 | 2.7 | 3.1 | 1.9 |

### Preparation of PU Synthetic Leather

### Scheme 1

PU synthetic leathers were prepared, which comprises the top coat layer, the base coat layer and the substrate layer.

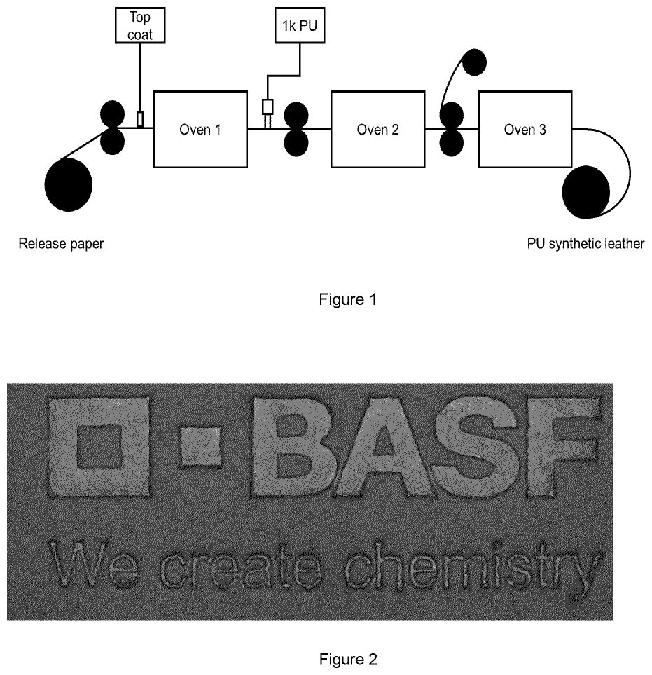

Processing refers to FIG. 1. As shown in FIG. 1, the processing of the polyurethane synthetic leather is as follows:

First, commercial formulation (Haptex CC 6945/91 C-CB, from BASF) for forming the top coat layer was applied with a thickness of 100 μm by knife coating within 4 hours onto a Favini B100 release paper, followed by drying in Oven #1 at 80° C. for 2 minutes and at 120° C. for 2 minutes. Next, each mixture for forming the base coat layer in Table 1 was applied with a thickness of 250 μm by knife coating on top of the dried top coat layer, and heated in Oven #2 at temperature of 50° C. and relative humidity of 50% for 1.5-10 minutes. Then, a substrate layer made of a polymeric composition of 70 wt % polyester and 30 wt % polyamide with a thickness of 1 mm was applied on the dried base coat layer, and the curing was carried out by heating in Oven #3 at temperature of 50° C. and relative humidity (R.H.) of 50% for 10-30 minutes, followed by pressing. PU synthetic leather was obtained after stripping the release paper. The experimental results of the PU leather performance were shown in Table 3.

TABLE 3

| | Curing in moisture (50° C., 50% R.H.) | | | Peel strength/ |
|---|---|---|---|---|
| No. | 10 min | 15 min | 30 min | (N/3 cm) |
| Exp. 1 | Grade 4 | Grade 4 | Grade 5 | 95 |
| Exp. 2 | Grade 4 | Grade 4 | Grade 5 | 90 |
| Exp. 3 | Grade 4, surface of | Grade 5 | Grade 5 | 50 |
| | leather is brittle | | | |
| Exp. 4 | Grade 4, surface of | Grade 5 | Grade 5 | 60 |
| | leather has a | | | |
| | certain strength | | | |
| Exp. 5 | Grade 4, surface of | Grade 5 | Grade 5 | 65 |
| | leather has a | | | |
| | certain strength | | | |
| Exp. 6 | Grade 1 | Grade 2 | Grade 4 | — |
| Comp. Exp. 1 | Grade 1 | Grade 1 | Grade 1 | — |
| Exp. 7 | Grade 4 | Grade 4 | Grade 5 | 85 |
| Exp. 8 | Grade 3 | Grade 4 | Grade 4 | 90 |
| Exp. 9 | Grade 3 | Grade 4 | Grade 5 | 49 |
| Comp. Exp. 2 | Grade 1 | Grade 2 | Grade 2 | 30 |

From the above results, it can be seen that the inventive examples of polyurethane prepolymer composition achieve better peel strength and curing property than the comparative examples.

### Scheme 2

The properties of the PU leather under different curing conditions were tested.

As to the tests in table 4 as below, the polyurethane prepolymer composition according to For. 2 was used to form the base coat layer, except that the curing conditions were varied in each test.

TABLE 4

| | | | | | Peel | Flexing | | Logo |
|---|---|---|---|---|---|---|---|---|
| | Curing | Curing performance | | | strength/ | 25° C., | −10° C., | embedding** |
| No. | condition | 10 min | 15 min | 30 min | (N/3 cm) | 100 K | 80 K | 160° C., 1 s |
| Solvent based PU | | — | — | — | — | — | — | 0.66 |
| leather | | | | | | | | |
| Water based PU | | — | — | — | — | — | — | 0.64 |
| leather | | | | | | | | |
| Exp. 2-1 | 30° C., 30% | Grade 1 | Grade 1 | Grade 4 | 95 | Pass | Pass | 0.67 |
| | R.H. | | | | | | | |
| Exp. 2-2 | 45° C., 30% | Grade 2 | Grade 4 | Grade 5 | 90 | Pass | Pass | 0.60 |
| | R.H. | | | | | | | |
| Exp. 2-3 | 80° C., 30% | Grade 5 | Grade 5 | Grade 5 | 90 | Pass | Pass | 0.60 |
| | R.H. | (5-6 min)* | | | | | | |
| Exp. 2-4 | 30° C., 50% | Grade 1 | Grade 2 | Grade 4 | 95 | Pass | Pass | 0.58 |
| | R.H. | | | | | | | |
| Exp. 2-5 | 45° C., 50% | Grade 4 | Grade 4 | Grade 5 | 90 | Pass | Pass | 0.57 |
| | R.H. | | | | | | | |
| Exp. 2-6 | 80° C., 50% | Grade 5 | Grade 5 | Grade 5 | 60 | Pass | Pass | 0.59 |
| | R.H. | (5 min)* | | | | | | |
| Exp. 2-7 | 90° C., 50% | Grade 5 | Grade 5 | Grade 5 | 55 | Pass | Pass | 0.53 |
| | R.H. | (5 min)* | | | | | | |
| Exp. 2-8 | 30° C., 70% | Grade 1 | Grade 2 | Grade 4 | 90 | Pass | Pass | 0.66 |
| | R.H. | | | | | | | |
| Exp. 2-9 | 45° C., 70% | Grade 4 | Grade 5 | Grade 5 | 80 | Pass | Pass | 0.61 |
| | R.H. | | | | | | | |
| Exp. 2-10 | 80° C., 70% | Grade 5 | Grade 5 | Grade 5 | 50 | Pass | Pass | 0.66 |
| | R.H. | (5 min)* | | | | | | |
| Exp. 2-11 | 30° C., 80% | Grade 1 | Grade 2 | Grade 4 | 90 | Pass | Pass | 0.67 |
| | R.H. | | | | | | | |
| Exp. 2-12 | 90° C., 80% | Grade 5 | Grade 5 | Grade 5 | 35 | Pass | Pass | 0.66 |
| | R.H. | (5 min)* | | | | | | |
| Exp. 2-13 | 95° C., 80% | Grade 5 | Grade 5 | Grade 5 | 30 | Pass | Pass | 0.66 |
| | R.H. | (5 min)* | | | | | | |
| Exp. 2-14 | 45° C., 95% | Grade 4 | Grade 5 | Grade 5 | 75 | Pass | Pass | 0.66 |
| | R.H. | | | | | | | |

*(5 min) means the curing time in the climate chamber.
**Logo embedding means average depth of logo (in mm).

As to the tests in table 5 as below, the polyurethane prepolymer composition according to For. 7 was used to form the base coat layer, except that the curing conditions were varied in each test.

TABLE 5

| | | | | | Peel | Flexing | |
|---|---|---|---|---|---|---|---|
| | | Curing performance | | | strength/ | 25° C., | −10° C., |
| No. | Curing condition | 10 min | 15 min | 30 min | (N/3 cm) | 100 K | 80 K |
| Exp. 7-1 | 30° C., 50% R.H. | Grade 1 | Grade 2 | Grade 4 | 85 | Pass | Pass |
| Exp. 7-2 | 45° C., 50% R.H. | Grade 4 | Grade 5 | Grade 5 | 70 | Pass | Pass |
| Exp. 7-3 | 60° C., 50% R.H. | Grade 5 | Grade 5 | Grade 5 | 70 | Pass | Pass |
| Exp. 7-4 | 70° C., 50% R.H. | Grade 5 | Grade 5 | Grade 5 | 65 | Pass | Pass |
| Exp. 7-5 | 75° C., 50% R.H. | Grade 5 | Grade 5 | Grade 5 | 60 | Pass | Pass |
| Exp. 7-6 | 80° C., 50% R.H. | Grade 5 | Grade 5 | Grade 5 | 50 | Pass | Pass |
| Exp. 7-7 | 30° C., 70% R.H. | Grade 1 | Grade 2 | Grade 4 | 80 | Pass | Pass |
| Exp. 7-8 | 45° C., 70% R.H. | Grade 4 | Grade 5 | Grade 5 | 70 | Pass | Pass |
| Exp. 7-9 | 60° C., 70% R.H. | Grade 5 | Grade 5 | Grade 5 | 65 | Pass | Pass |
| Exp. 7-10 | 70° C., 70% R.H. | Grade 5 | Grade 5 | Grade 5 | 60 | Pass | Pass |
| Exp. 7-11 | 75° C., 70% R.H. | Grade 5 | Grade 5 | Grade 5 | 50 | Pass | Pass |
| Exp. 7-12 | 80° C., 70% R.H. | Grade 5 | Grade 5 | Grade 5 | 50 | Pass | Pass |

From the above results, it can be seen that the inventive artificial leather, produced from the inventive non-solvent one-component polyurethane prepolymer composition, has logo embedding property equivalent to or better than that of solvent based PU leather or water-based PU leather.

### Scheme 3

The following components and amounts in table 6 were used to prepare the PU prepolymer. In each case, all the components of the PU prepolymer were mixed to form a mixture for forming the base coat layer of PU synthetic leather. The filler CaCO₃ contains 0.35 wt % of water.

TABLE 6

| Weight/part | For. 2 | Comp. For. 3 |
|---|---|---|
| ISO #2 | 36.6 | 70 |
| Polyol #1 | 31.7 | 15 |
| Polyol #2 | 31.7 | 15 |
| CaCO₃ | 30 | 30 |
| DMDEE | 2 | 2 |
| Diacetylmonoxime | 0 | 18 |
| NCO/% | 10.1 | 11.6 |
| Blocked NCO/% | 0 | 10.8 |

Comp. For. 5-7 were prepared by blending PU prepolymers of For. 2 and Comp. For. 3 in different ratios to obtain PU prepolymer composition having different amounts of blocked isocyanate group, as shown in table 7. The preparation of PU synthetic leather is the same as that in example 1.

TABLE 7

| | Comp. | Comp. | Comp. |
|---|---|---|---|
| | For. 4 | For. 5 | For. 6 |
| Amount of For. 2 | 75 wt % | 80 wt % | 83.3 wt % |
| Amount of Comp. For. 3 | 25 wt % | 20 wt % | 16.7 wt % |
| NCO/% | 10.4 | 9.16 | 8.59 |
| Blocked NCO/% | 2.7 | 2.16 | 1.80 |

The leather samples made from polyurethane prepolymer composition of Comp. For. 4 through 6 were cured at temperature of 80° C., relative humidity of 70% for 10-30 minutes. The results were shown in table 8.

TABLE 8

| | Curing in moisture | | | Peel strength/ |
|---|---|---|---|---|
| No. | 10 min | 15 min | 30 min | (N/3 cm) |
| Comp. | obvious nail | obvious nail | obvious nail | — |
| Exp. 4 | print, no rebound | print, no rebound | print, no rebound | |
| Comp. | obvious nail | obvious nail | obvious nail print, | 10 |
| Exp. 5 | print, no rebound | print, no rebound | rebound after 2-3 s | |
| Comp. | obvious nail print, | obvious nail print, | — | 15 |
| Exp. 6 | hard rebound | rebound after 2-3 s | | |

To compare the effects of blocked and unblocked isocyanate groups on their properties, we conducted the following experiments to de-block the isocyanate groups, wherein the leather samples made from PU prepolymer composition of Comp. For. 4 through 6 were cured at 80° C., relative humidity of 70% for 10-30 minutes, and then transferred to an oven at 130-140° C. for 5-30 minutes, to convert a majority of the blocked isocyanate groups to the native isocyanate group. The results were shown in table 9.

TABLE 9

| | | | | Peel | | |
|---|---|---|---|---|---|---|
| | Curing in Oven | | | strength/ | | ΔH(max − |
| No. | 5 min | 10 min | 30 min | (N/3 cm) | Flexing | min), mm |
| Comp. | Grade 1 | Grade 1 | Grade 1 | — | | — |
| Exp. 4 | | | | | | |
| Comp. | Grade 2 | Grade 4 | Grade 5 | 25 | | 0.52 |
| Exp. 5 | | | | | | |
| Comp. | Grade 5 | Grade 5 | Grade 5 | 35 | Pass | 0.39 |
| Exp. 6 | | | | | | |

From the above results in table 8 and table 9, it can be seen that the leather samples made from PU prepolymers compositions containing blocked isocyanate group (NCO) have low peel strength and curing property, indicated by the low grade of curing, low peel strength, and reduced depth of logo embedding. The PU prepolymer composition of Comp. Exp. 4 which contains blocked isocyanate group (NCO) of 2.7% have significantly worse curing property than Comp. Exp. 6, which contains blocked isocyanate groups (NCO) of 1.8%.

In addition, it also can be seen that for the leather samples made from the same formulation, the leather samples in table 8, which contain blocked isocyanate groups, show significantly lower peel strength and curing property than the corresponding leather samples in table 9, which merely contains a small amount of blocked isocyanate groups.

### Scheme 4

For. 10 was selected for preparing PU synthetic leather with the filler sodium metasilicate nonahydrate (CAS 13517-24-3) containing water of crystallization, which kept the synthetic leather at a 50-60% R.H. at the oven temperature as shown in table 10. Then there was no need of moisture control oven to provide water. The experimental results of the PU Leather performance were shown in Table 10.

TABLE 10

| | | | | | Peel | Flexing | |
|---|---|---|---|---|---|---|---|
| | Oven | Curing performance | | | strength/ | 25° C., | −10° C., |
| No. | temperature | 10 min | 15 min | 30 min | (N/3 cm) | 100 K | 80 K |
| Exp. | 70° C. | Grade 1 | Grade 1 | Grade 1 | 50 | Pass | Pass |
| 10-1 | | | | | | | |
| Exp. | 80° C. | Grade 3 | Grade 4 | Grade 5 | 50 | Pass | Pass |
| 10-2 | | | | | | | |
| Exp. | 90° C. | Grade 5 | Grade 5 | Grade 5 | 45 | Pass | Pass |
| 10-3 | | | | | | | |
| Exp. | 95° C. | Grade 5 | Grade 5 | Grade 5 | 40 | Pass | Fail |
| 10-4 | | | | | | | |

From the above results, it can be seen that with the aid of water of crystallization present in the filler, the leather samples made from PU prepolymer compositions have good properties in terms of curing property, peel strength and flexing by controlling temperature alone. It also can be seen that compared with the leather samples cured in moisture (see, examples 7-1 to 7-12), the leather samples prepared by relying on water of crystallization of the filler need to be cured at higher temperatures, to obtain good properties.

The structures, materials, compositions, and methods described herein are intended to be representative examples of the invention, and it will be understood that the scope of the invention is not limited by the scope of the examples. Those skilled in the art will recognize that the invention may be practiced with variations on the disclosed structures, materials, compositions and methods, and such variations are regarded as within the ambit of the invention. Thus, it is intended that the present invention cover such modifications and variations as come within the scope of the appended claims.

1. A polyurethane prepolymer composition, comprising a reaction product of:
an isocyanate component; and
a polyol component,
wherein the reaction product comprises isocyanate groups at an amount of from 5.0 to 13.0 wt %, based on the total weight of the isocyanate component and the polyol component; and
the polyol component has a functionality in a range of from 1.5 to 3.0.

2. The polyurethane prepolymer composition according to claim 1, wherein the amount of the isocyanate groups is from 8.0 to 12.5 wt %, based on the total weight of the isocyanate component and the polyol component.

3. The polyurethane prepolymer composition according to claim 1, wherein the polyurethane prepolymer composition contains no blocked isocyanate group.

4. The polyurethane prepolymer composition according to claim 1, wherein the isocyanate component is selected from the group consisting of an aliphatic diisocyanate, an aliphatic polyisocyanate, a cycloaliphatic diisocyanate, a cycloaliphatic polyisocyanate, an aromatic diisocyanate, an aromatic polyisocyanate, and mixtures thereof.

5. The polyurethane prepolymer composition according to claim 1, wherein the polyol component has a functionality in a range of from 1.9 to 2.8.

6. The polyurethane prepolymer composition according to claim 5, wherein the polyol component has a weight-average molecular weight in a range of from 500 g/mol to 10000 g/mol and a OH value in a range of from 20 to 400 mgKOH/g.

7. The polyurethane prepolymer composition according to claim 1, wherein the polyurethane prepolymer composition further comprises at least one catalyst which is selected from the group consisting of a tin compound, an amine compound, an imidazole compound, a morpholine compound, and mixtures thereof.

8. The polyurethane prepolymer composition according to claim 1, wherein the polyurethane prepolymer composition further comprises at least one filler which is selected from the group consisting of calcium carbonate, carbon black, silica, hydrated silica, alumina, titania, zinc oxide, talc, mica, clay, kaolinite, wollastonite, montmorillonite, aluminum hydroxide, barium sulfate, lignin, wood fiber, wood flour, a monohydrate of magnesium carbonate, a dihydrate of magnesium carbonate, a trihydrate of magnesium carbonate, a tetrahydrate of magnesium carbonate, a pentahydrate of magnesium carbonate, a monohydrate of magnesium sulfate, a tetrahydrate of magnesium sulfate, a pentahydrate of magnesium sulfate, a hexahydrate of magnesium sulfate, a heptahydrate of magnesium sulfate, copper(II) sulfate pentahydrate, calcium sulfate hemihydrate, calcium sulfate dihydrate, ferrous sulfate heptahydrate, aluminum potassium sulfate dodec-ahydrate, sodium sulfate decahydrate, sodium metasilicate pentahydrate, sodium metasilicate nonahydrate, and mixtures thereof.

9. A process for producing the polyurethane prepolymer composition according to claim 1, comprising mixing all the components of the composition.

10. A laminate comprising the polyurethane prepolymer composition according to claim 1 as a base coat layer.

11. The laminate according to claim 10, wherein the polyurethane prepolymer composition is sandwiched between a top coat skin layer and a substrate layer.

12. The laminate according to claim 10 wherein the laminate is a synthetic leather.

13. A process for producing a laminate, comprising the following steps:
(1) applying the polyurethane prepolymer composition according to claim 1 onto a release paper; and
(2) curing the applied composition in the presence of water,
wherein in the curing step (2), the temperature is in a range of 45-90° C.

14. The process according to claim 13, wherein the water is introduced in the curing step (2) by controlling the moisture at the curing atmosphere.

15. The process according to claim 14, wherein the moisture is controlled to have a relative humidity in a range of 30-95%.

16. The process according to claim 13, wherein the water is introduced in the curing step (2) by adding a filler which has water of crystallization, absorbed free water and/or adsorbed free water.

17. The process according to claim 16, wherein the filler is selected from the group consisting of a monohydrate of magnesium carbonate, a dihydrate of magnesium carbonate, a trihydrate of magnesium carbonate, a tetrahydrate of magnesium carbonate, and a pentahydrate of magnesium carbonate, a monohydrate of magnesium sulfate, a tetrahydrate of magnesium sulfate, a pentahydrate of magnesium sulfate, a hexahydrate of magnesium sulfate, and a heptahydrate of magnesium sulfate, copper(II) sulfate pentahydrate, calcium sulfate hemihydrate, calcium sulfate dihydrate, ferrous sulfate heptahydrate, aluminum potassium sulfate dodecahydrate, sodium sulfate decahydrate, sodium metasilicate pentahydrate, sodium metasilicate nonahydrate, and mixtures thereof.

18. A method of using the laminate according to claim 10, the method comprising using the laminate in apparel, accessories, package, electronic devices, furniture, upholstery, decorations, sports items, or leisure products.

19. The polyurethane prepolymer composition according to claim 1, wherein the amount of the isocyanate groups is from 9.0 to 12.0 wt %, each based on the total weight of the isocyanate component and the polyol component.

20. The polyurethane prepolymer composition according to claim 1, wherein the isocyanate component is diphenylmethane diisocyanate.
